(19) United States
(12) Patent Application Publication
(10) Pub. No.: US 2003/0058082 A1
(43) Pub. Date: Mar. 27, 2003

(54) Method and system for providing a visitor identification badge

(76) Inventors: Vishal Mallick, Birmenstorf (CH); Bruno Ruttimann, Winterthur (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/244,394

(22) Filed: Sep. 17, 2002

(30) Foreign Application Priority Data
Sep. 25, 2001 (EP) 01810935.5

(51) Int. Cl. H04Q 1/00; G05B 19/00

(52) U.S. Cl. 340/5.6; 340/5.8

(57) ABSTRACT

In the inventive method and system for providing a visitor identification badge, a terminal device or virtual reception console (17) registers visitor information and, in accordance with an access status of the visitor, issues a visitor identification badge. The access status is determined by establishing a voice communication link with a host communication device (5) associated with a host person and by accepting confirmation information entered by the host.

### FIELD OF THE INVENTION

The invention relates to the field of access control system. It relates to a method and system for providing a visitor identification badge as described in the preamble of claim 1 and 10, respectively.

### BACKGROUND OF THE INVENTION

Access to premises such as buildings and building complexes is managed by access control systems. Persons allowed to enter the premises are issued identification badges which usually comprise a machine-readable element such as a magnetic strip, microprocessor and/or wireless transponder. An access control system maintains badge identifiers associated with persons such as regular personnel and sporadic visitors, and allows such a person access to specific localities depending on access rights associated with a badge. For this purpose, the access control system comprises or is operatively connected to badge readers and automatic doors located throughout the premises.

Typically, an access control system is part of or comprises or is interfaced to a visitor management system. A visitor management system keeps track of access rights of temporary visitors. According to the state of the art, a visitor management system is operated by a receptionist. The receptionist, upon arrival of a visitor, confirms the visitor's identity by checking a list of scheduled visitors and/or phoning an employee expecting the visitor. The list of expected visitors, current and checked-out visitors is maintained by the visitor management system. Visitor management systems typically provide software for managing a visitor database and a badge printer which issues a badge that can be read by the access control system. The badge and/or the access control system is programmed to allow the visitor access to specific areas appropriate with the goal of the visit. Such a system, including a virtual reception ‘pod’ is described e.g. in www.nexus-technology.com/case/print/lotus.pdf.

Current systems require a human operator to handle the confirmation of access rights. This is not effective for premises where there is not sufficient room for a reception or where a plurality of entrances exists or where there are too few visitors or for operation outside normal working hours.

### DESCRIPTION OF THE INVENTION

It is therefore an object of the invention to create a method and system for providing a visitor identification badge of the type mentioned initially, which allows to give a visitor access in an easy manner while maintaining security and safety advantages conferred by a visitor management system and by reliable visitor identification.

These objects are achieved by a method and system for providing a visitor identification badge according to the claims 1 and 10.

In the inventive method and system for providing a visitor identification badge, a terminal device registers visitor information and, in accordance with an access status of the visitor, issues a visitor identification badge. The access status is determined by establishing a voice communication link with a host communication device associated with a host person and by accepting confirmation information entered by the host.

A main advantage of the invention is that the confirmation of access may be effected by an arbitrary employee located at any phone or other communication device, and not only by a receptionist operating a dedicated terminal or user interface program of a visitor management system or access control system.

In a preferred embodiment of the invention, the host communication device is a telephone, in particular a mobile phone. In a further preferred embodiment of the invention, the host communication device is a control device for a meeting room.

Further preferred embodiments are evident from the dependent patent claims.

### BRIEF DESCRIPTION OF THE DRAWINGS

The subject matter of the invention will be explained in more detail in the following text with reference to preferred exemplary embodiments which are illustrated in the attached drawing, in which

FIG. 1 schematically shows a system according to the invention. The reference symbols used in the drawing, and their meanings, are listed in summary form in the list of reference symbols.

### DETAILED DESCRIPTION OF THE PREFERRED EMBODIMENT

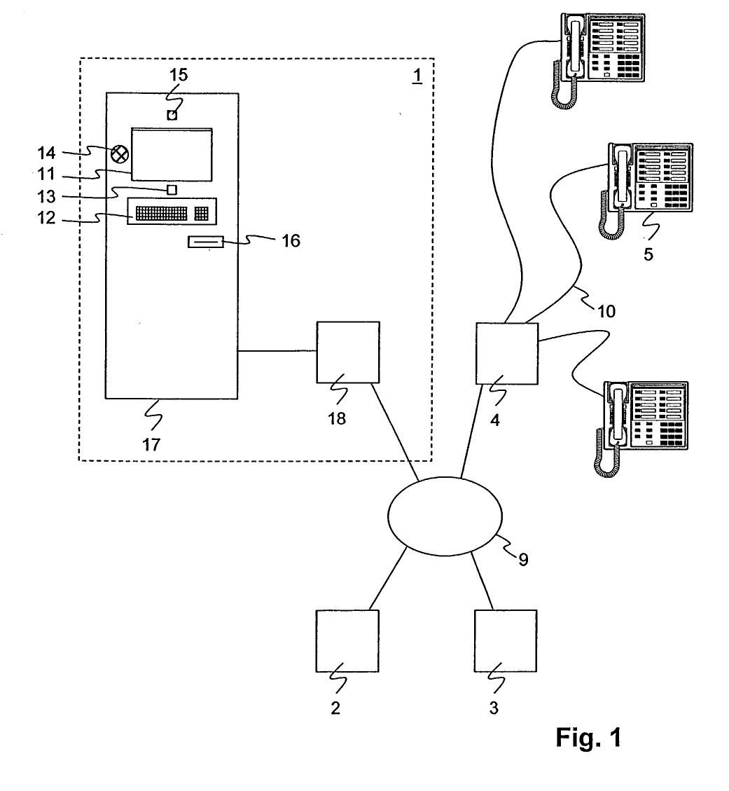

FIG. 1 schematically shows a system according to the invention. A terminal device or virtual reception 1 comprises a virtual reception console 17 and a controller 18. The virtual reception console 17 is located in a freely accessible entrance area of the premises. The virtual reception console 17 comprises an output device such as a monitor 11 and an input device such as a keyboard 12. In another preferred embodiment of the invention the input and output devices are implemented as a touch screen. The virtual reception console 17 further comprises an audio input device such as a microphone 13, an audio output device such as a loudspeaker 14, a badge dispenser 16 and optionally a video input device such as a video camera 15. For privacy reasons, the microphone 13 and loudspeaker 14 are preferably combined in a telephone handset. The badge dispenser 16 is configured to output either a reusable badge with a known identification code or to print a single use badge on which the name and status of a visitor may be printed.

The controller 18 of the virtual reception 1, an access control system 2, a visitor management system 3 and a telephone system 4 are interconnected by a communication network 9. These interconnected systems are implemented as physically separate data processing units and/or as separate software processes running on a central or on a distributed processing system. The telephone system 4 communicates with a host communication device, typically a telephone 5, over a telephone link 10.

The visitor management system 3 maintains a database comprising data records with information about visitors, visits and hosting employees as well as relations between these. In a preferred embodiment of the invention, the access control system 2 comprises the visitor management system 3.

Depending on the interfaces and technical capabilities of the systems connected by the communication network 9, the communication network 9 is implemented by dedicated connections and/or a computer network linking the separate controllers or computers, and/or by software interface mechanisms and standards such as CORBA, COM, and Java-based ones. A commercial interfacing system is offered for example by SKYVA International, Cambridge, Mass., USA, using a cross system message broker and a business object modeller.

An example for the integration and interfacing of a building control system with a telephone system is shown in U.S. Pat. No. 6,192,282 which is herewith incorporated in its entirety by reference. The document shows a modular building automation system in which a set of interprocess control commands define an interprocess control protocol which is utilized in high level scripts and control applications. In particular, it is shown how a telephone system is interfaced to a variety of other systems such as security, intercom system, local area network etc. Alternatively, such an interface is realized using JTAPI, which is a standard Java™ API (Application Program interface) for telephony call control. JTAPI enables the creation of portable Java™ software products that can operate on any telephony product that exposes its services through a JTAPI interface.

In a preferred embodiment of the invention, the host communication device 5 is not a telephone but a computer or a PDA (personal digital assistant) or any similar device with voice and possibly also video communication capabilities. In a particular preferred embodiment of the invention, the host communication device 5 is a control device for a meeting room, that is, it is configurated to operate technical devices such as shades, lighting, video screens, video conferencing etc. associated with the meeting room.

The voice and possibly also a video communication link between the telephone system 4 and such a host communication device 5 is established by a traditional phone link or by known communication protocols for transmitting real-time audio and video information over a computer network, such as “voice over IP” and streaming video.

The method according the invention is now described in terms of the actions of a visitor and a hosting employee. From their interactions with the inventive system, the technical features required to implement the inventive method are evident.

A visitor arrives at the premises. The visit has been scheduled earlier by the employee or by a receptionist, using an appropriately programmed user interface to the virtual reception 1 or the visitor management system 3. Alternatively, the visit is unexpected and has not been scheduled. The main steps now are

visitor identification on arrival,

connecting the visitor to the hosting employee,

accepting the visitor, and

automatic badge id registration and badge delivery,

and shall be explained in more detail:

For the main step “visitor identification on arrival”, the normal flow of events is the following:

1. The visitor touches the touch-screen to announce his presence to the system.

2. The virtual reception 1 displays a choice of languages.

3. The visitor selects the language of his choice. The visitor may at any later time switch the language.

4. The visitor selects a mode: “scheduled visitor” or “unexpected visitor”.

The visitor may at any later time change between the two modes scheduled and unexpected.

5. The virtual reception 1 displays an on-screen keyboard. The on-screen keyboard layout is chosen according to the language selected.

6. The visitor enters data identifying himself, such as name, surname, company.

7. The visitor enters data identifying the hosting employee, such as name and/or telephone number.

8. The visitor initiates the registration process.

9. If in scheduled mode, the system searches for data records representing a scheduled visit with matching employee, matching visitor and matching arrival time slot.

10. If in unexpected mode, the system searches for a matching employee,

11. If matching records are found, the registration process is stopped and the visitor is notified about the successful registration process.

12. If no matching records are found, the visitor is informed about the failure. The system will give a hint about the data items not found, e.g. visitor, visit and/or hosting employee. The visitor may correct his entries, switch the language or may switch to “unexpected visitor” mode. After a predetermined number of failed identification attempts the system tells the visitor to ask for help at the traditional reception.

13. If matching records are found, but visitor is in wrong building (i.e. the host resides in other building), then the system tells the visitor to register in the correct building and preferably displays a map of the premises showing a way to the correct building.

The visitor is now registered with the visitor management system 3. This means that a scheduled visitor's data as entered matches with data found in the visitor management system 3 database. The following data records must match: visitor, visit, hosting employee. For an unexpected visitor, entered data regarding the host matches a hosting employee's record in the visitor management system 3 database.

For the main step “Connecting the visitor to the hosting employee”, the normal flow of events is the following:

1. The system establishes an audio connection between the virtual reception 1 and the hosting employee's telephone 5, based on the hosting employees phone number. Alternatively, if the host entered a different contact number than his own phone number in the visit record, this contact number is used. For example, this number is associated with a meeting room and/or an associated meeting room control device. Alternatively, the system also establishes a video connection.

2. If the connection is established, then the visitor can communicate with the hosting employee.

3. If the connection is not established or the call was not answered by the hosting employee, then the virtual reception 1 establishes a connection to a representative of the host or the traditional reception, or directs the visitor to the traditional reception.

For the main step “Accepting the visitor”, the normal flow of events is the following:

1. If the hosting employee is connected to the visitor, while talking to the visitor the hosting employee can accept the visitor and confirm to the system that the visitor is to be granted access. This is preferably done by the hosting employee dialling a code on his phone. In a preferred embodiment of the invention, the virtual reception 1 prompts the hosting employee by instructing him with a pre-recorded or computer generated audio message to dial a predetermined code or just one key of the phone in order to confirm acceptance of the visitor. In the case that the host communication device 5 is not a telephone but a computer or PDA, then the confirmation is effected through a user interface program to the virtual reception 1, where the user interface runs on the host communication device 5. If a receptionist of the traditional reception is connected to the visitor, then the visitor acceptance is effected through a graphic user interface running on a computer connected to the virtual reception 1.

2. The dialled code or confirmation signal is transmitted to the virtual reception 1.

3. If the visitor is unexpected, then the visitor's registration data is used to create, in the visitor management system 3 database, a visitor record and an associated visit record linked to the hosting employee.

For the main step “automatic badge id registration and badge delivery”, the normal flow of events is the following:

1. The dialled code or confirmation is checked by the virtual reception 1. If the code is valid, an access status associated with the visitor is set to “access allowed” and a command to deliver a valid badge is transmitted to the virtual reception console 17.

2. The virtual reception console 17 notifies the visitor, e.g. by means of the monitor 11, that a badge shall be delivered.

3. The badge dispenser 16 reads the badge id.

4. The badge dispenser 16 delivers a valid badge to the visitor.

5. A buzzing sound is generated.

6. If the visitor takes the badge, the buzzing sound is stopped. The badge id will be registered with the virtual reception 1 where it will be associated with the visitor and thus with the access rights associated with that visitor. The event is logged.

7. If the visitor does not take the badge during a given time interval, the badge id is invalidated by the system and cannot be used for the rest of the day or until it is revalidated manually by e.g. a receptionist.

8. The VR console dialog terminates.

In summary, the inventive method comprises the steps of:

1. a virtual reception console 17 registering visitor information.

2. determining an access status associated with the visitor, by:

a) from the visitor information, determining a host communication device 5 associated with a host person. Typically, the telephone 5 is located at a common reception that is arranged to process all visitors.

b) establishing a voice communication link between the virtual reception console 17 and the host communication device 5.

c) outputting a confirmation prompt at the host communication device 5,

d) accepting confirmation information entered by a user at the host communication device 5.

e) based on said confirmation information, determining the access status associated with the visitor.

3. transmitting the access status to the virtual reception console 17.

4. the virtual reception console 17, depending on the access status, issuing a visitor identification badge.

Accordingly, the system for providing a visitor identification badge according to the invention, comprises

1. means for registering visitor information at a virtual reception console 17

2. means for determining an access status associated with the visitor, which means comprise

a) means for determining, from the visitor information, a host communication device 5 associated with a host person,

b) means for establishing a voice communication link between the virtual reception console 17 and the host communication device 5,

c) means for outputting a confirmation prompt at the host communication device 5,

d) means for accepting confirmation information entered by a user at the host communication device 5,

e) means for determining, based on said confirmation information, the access status associated with the visitor.

3. means for transmitting the access status to the virtual reception console 17, and

4. means for the virtual reception console 17, depending on the access status, issuing a visitor identification badge.

In the above example, certain functions such as visitor/visit database management were associated with specific subsystems, e.g. the visitor management system 3. It is evident that a number of these functions may be performed by another subsystem without changing the essence of the invention.

The user interfaces visible at the virtual reception console 17 and possibly the host communication device 5 are preferably implemented with said devices operating as web clients and the virtual reception 1 operating as a web server. As a result, only a standard web browser needs to be installed at said devices, rather than custom interface software.

In a further preferred embodiment of the invention, the telephone 5 is not wire based but a cellular phone. This allows for a scenario where the host is not required to be physically present at the premises. For example, an employee may grant a trusted person access to retrieve documents from his office during the weekend, when no other employees or a receptionist would be around to assist. The inventive method and system remain essentially the same. However, depending on the operator's rules it might not be allowed to confirm badge issue by a hosting employee that is not in the premises. In this case, the virtual reception 1 requests the status of the hosting employee from the visitor management system 3 (which also manages the presence or absence of regular employees) and allows the confirmation only if the hosting employee is known to be present at the premises.

List of Designations

1 terminal device, virtual reception

2 access control system

3 visitor management system

4 telephone system

5 host communication device, computer, telephone

9 communication network

10 telephone link

11 output device, monitor

12 input device, keyboard

13 audio input device, microphone

14 audio output device, loudspeaker

15 video input device, video camera

16 badge dispenser

17 virtual reception console

18 controller

1. Method for providing a visitor identification badge, where the method comprises the steps of
a terminal device (17) registering visitor information,
determining an access status associated with the visitor,
transmitting the access status to the terminal device (17), and
the terminal device (17), depending on the access status, issuing a visitor identification badge,
characterized in that the step of determining the access status associated with the visitor comprises by the steps of:
from the visitor information, determining a host communication device (5) associated with a host person,
establishing a voice communication link between the terminal device (17) and the host communication device (5),
accepting confirmation information entered by a user at the host communication device (5),
based on said confirmation information, determining the access status associated with the visitor.

2. Method of claim 1, characterized in that the host communication device (5) is a telephone.

3. Method of claim 2, characterized in that the host communication device (5) is a wire based telephone.

4. Method of claim 2, characterized in that the host communication device (5) is a mobile telephone.

5. Method of claim 1, characterized in that the host communication device (5) is a personal digital assistant (PDA).

6. Method of claim 1, characterized in that the host communication device (5) is a control device for a meeting room.

7. Method of claim 1, wherein the visitor information comprises information identifying the visitor.

8. Method of claim 7, wherein the step of determining a host communication device (5) associated with a host person comprises
searching for a database record representing a scheduled visit and matching visitor information, and
if such a database record is found, determining an associated hosting person from the database record.

9. Method of claim 8, wherein the the step of determining the access status associated with the visitor is performed by an access control system (2) that comprises a visitor management system (3) and is interfaced to a telephone system (4).

10. A system for providing a visitor identification badge, where the system comprises
means for registering visitor information at a terminal device (17),
means for determining an access status associated with the visitor,
means for transmitting the access status to the terminal device (17), and
means for the terminal device (17), depending on the access status, issuing a visitor identification badge,
characterized in that the means for determining the access status associated with the visitor comprises:
means for determining, from the visitor information, a host communication device (5) associated with a host person,
means for establishing a voice communication link between the terminal device (17) and the host communication device (5),
means for outputting a confirmation prompt at the host communication device (5),
means for accepting confirmation information entered by a user at the host communication device (5),
means for determining, based on said confirmation information, the access status associated with the visitor.
